(19) United States
(12) Patent Application Publication
(10) Pub. No.: US 2008/0173048 A1
(43) Pub. Date: Jul. 24, 2008

(54) Handcuffs

(76) Inventors: Keun Jung Kim, Clifton, VA (US); Kay KC Kim, Clifton, VA (US)

Correspondence Address: Keun Jung Kim / Kay KC Kim, 6823 Union Mill Rd, Clifton, VA, 20124, US

(21) Appl. No.: 12/007,395

(22) Filed: Jan. 10, 2008

Related U.S. Application Data
(63) Continuation of application No. 11/143,284, filed on Jun. 3, 2005, now abandoned.

(51) Int. Cl. E05B 75/00

(52) U.S. Cl. 70/16

(57) ABSTRACT

A set of handcuffs which has a first bracelet, a second bracelet, and a central holder. In one embodiment, the central holder contains a one-way clutch and a retraction mechanism. In a second embodiment, the central holder comprises a retraction mechanism. One end of a line is attached to the second bracelet and the other end of the line is attached to the retraction mechanism, which urges the second bracelet toward the central holder. When the first bracelet is open, the line may be extended from the central holder or retracted to the central holder. When the first bracelet is closed, the retraction mechanism is engaged, causing the retraction mechanism to allow retraction of the bracelet toward the central holder, but to prevent extension of the bracelet away from the central holder. A line stopper is disclosed which connects with the line between the retraction mechanism and the second bracelet.

### CROSS-REFERENCE TO RELATED APPLICATIONS

This application is a continuation of application Ser. No. 11/143,284, filed Jun. 3, 2005.

### STATEMENT REGARDING FEDERALLY SPONSORED RESEARCH OR DEVELOPMENT

(Not Applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the Invention

This invention relates to handcuffs. More particularly, this invention relates to a set of handcuffs which may be applied to the subject while the hands are far apart and the distance between the two bracelets will decrease, but will never increase.

2) Description of the Related Art

It is known to use a restraining system to hold a subject's hands together. when using the restraining systems disclosed in the prior art, three of four arresting officers must use overpowering force to put a handcuff or restraining system on a resisting subject. The device in U.S. Pat. No. 6,026,661 issued to spiropoulus Feb. 22, 2000 allows the arresting officers to put handcuffs of the subject with ease, but they have to use force by using a ratcheting mechanism similar in design to a fishing reel. Such mechanism allows the arresting officers to, in effect, “reel in” each restraint until such restraints are brought together in a closed relationship. This is a better device than The fixed-length handcuffs, but when the subject resists, the ratcheting mechanical reel device could become a dangerous weapon as the subject could swing it at the arresting officers. Therefore the arresting officers must “reel in” the restraint, using force.

U.S. Pat. No. 6,360,747B1 issued to Velarde et al Mar. 26, 2002 shows a restraining system can be adjusted between a tight position to constrain a violent subject and a loose position which allows the subject to walk with difficulty. In this system, the distance between the handcuffs is always constant.

### BRIEF SUMMARY OF THE INVENTION

The present invention solves the above-noted problems of the fixed-length cuff and restraining systems and the “reel in” systems by providing a set of handcuffs which has an adjustable distance between the bracelets of the handcuffs. The bracelets of the handcuffs may be applied to the subject while the subject's hands are far apart and will retract automatically to a predetermined distance. Thus, the arresting officer does not need to have the hands of the subject together in order to apply the handcuffs. In the present invention the handcuffs maintain the bracelets locked while the bracelets are retracting, thus providing a continual limiting of movement of the subject while the subject is securely locked.

This invention is designed to help the arresting officer. When the subject resists arrest this set of handcuffs gives the officer the freedom of not having to force the subject's hands together to put handcuffs onto the subject. This set of handcuffs is not fixed in length. Rather, it may become any length which is required and it may retract to a predetermined size. While it is retracting, the bracelets are constantly locked in order to securely restrain a subject. The first advantage of this set of handcuffs over the prior art is that it may become any length by merely opening the handcuff's storage compartment without a key. The second advantage is that a retracting device retracts one of the handcuffs automatically to the original position once the handcuffs are on the subject. The third advantage is that the distance between the handcuffs may not increase, but may only decrease while the handcuffs are retracting to the original position. The fourth advantage is that when one bracelet is on the subject, the arresting officer can stay away from a dangerous subject and lock the other bracelet to any anchored place to restrain the subject. This is made possible by an automatic extendable and/or retractable length control feature of the handcuffs.

### BRIEF DESCRIPTION OF THE SEVERAL VIEWS OF THE DRAWINGS

FIG. 1 is a front elevational view of the set of handcuffs of the first embodiment of the present invention in closed mode with the line retracted.

FIG. 2 is a front elevational view of the set of handcuffs of the first embodiment of the present invention with the first bracelet partially open and line extended.

FIG. 3 is a front elevational view of the set of handcuffs of the first embodiment of the present invention in closed mode with the line extended.

FIG. 4 is a front elevational view of the set of handcuffs of the first embodiment of the present invention with the first bracelet fully open and the line extended.

FIG. 5 is an exploded perspective elevational view of the one-way clutch mechanism of the handcuffs of the first embodiment of the present invention.

FIG. 6 is an exploded perspective elevational view of the retraction mechanism of the handcuffs of the first embodiment of the present invention.

FIG. 7 is a front elevational view of the locking mechanism.

FIG. 8 is an enlarged perspective elevational view of the locking mechanism.

FIG. 9 is an enlarged perspective elevational view of the proximal end of the first bracelet of the first embodiment.

FIG. 10 is a top elevational view, partly in cut-away, showing the relationship between the clutch and the retraction mechanism of the handcuffs of the first embodiment of the present invention.

FIG. 11 is a front elevational view, partly in cut-away, of the handcuffs of the first embodiment of the present invention in closed mode with the line retracted.

FIG. 12 is a top view of the second embodiment of the invention wherein there is no clutch.

FIG. 13 is an exploded perspective view of the retraction mechanism of the second embodiment of the invention.

FIG. 14 is an exploded perspective view of the keyhole mechanism of the second embodiment.

FIG. 15 is of a front elevational view of a set of handcuffs according to this invention having a line stopper.

FIG. 16 is a front elevational view showing detail of the line stopper.

### DETAILED DESCRIPTION OF THE INVENTION

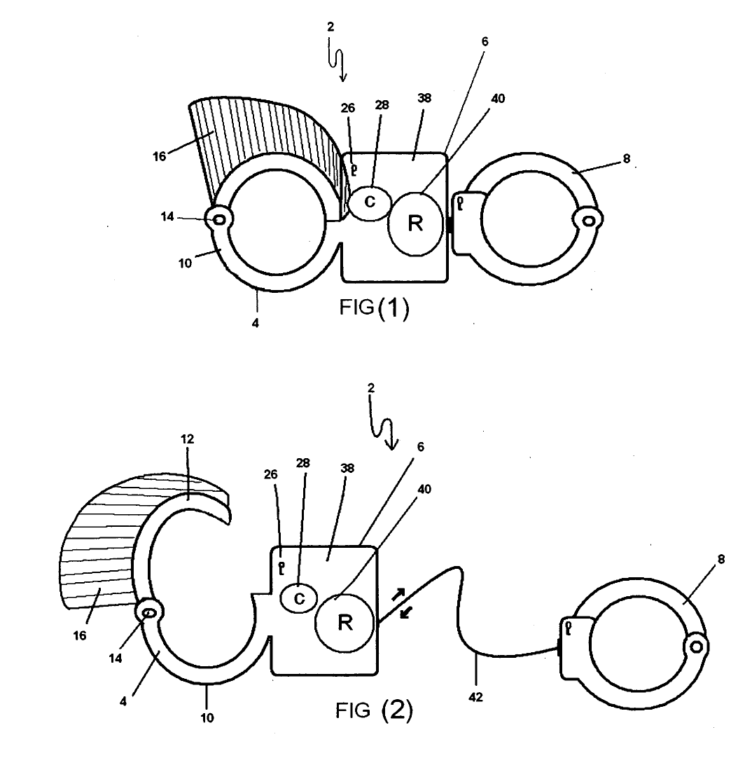

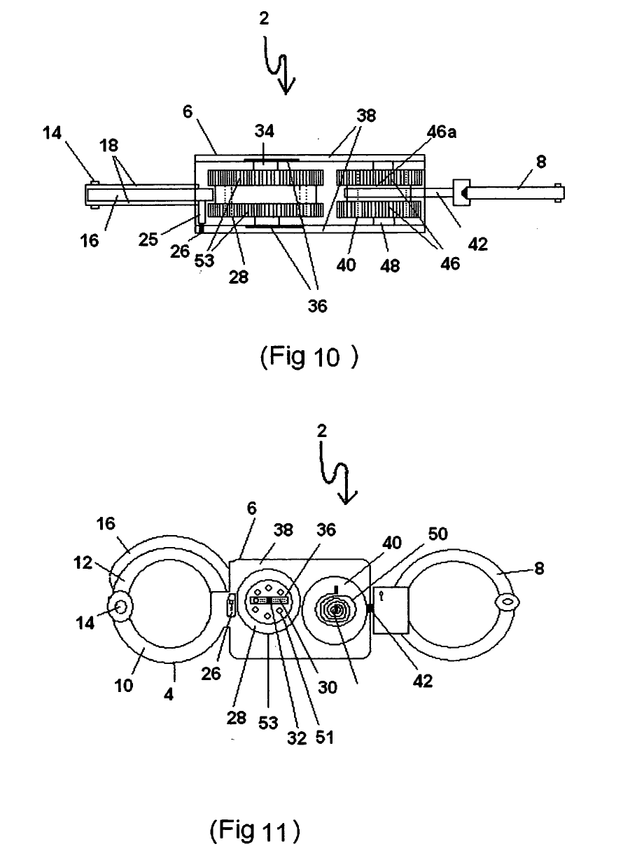

The first embodiment of this invention will be described with reference to FIGS. 1-11. With reference to these drawings a clear understanding of the handcuffs 2 of the first embodiment of the invention may be had.

The set of handcuffs 2 is made up of a first bracelet 4 on the left, a central holder 6, and a second bracelet 8 on the right.

The first bracelet 4 is seen on the left. The first bracelet 4 contains a lower section 10 and an upper section 12 connected by a pivot pin 14. A clutch press mechanism 16 is attached to outer parts 18 of the upper section 12 of the first bracelet 4. The details of the upper section 12 of the first bracelet 4 are best seen in FIGS. 8-10. This section 12 has a series of ratchets 20 on the end opposite the pivot pin 14, which ratchets 20 mesh with corresponding pawls 22 located in the central holder 6 to allow the upper section 12 to travel downwardly in a tightening direction, but do not allow the upper section 12 to travel upwardly in a loosening direction. The clutch press mechanism 16 comprises a plate 24 containing a rounded outer surface extending from the central part of the upper section 12.

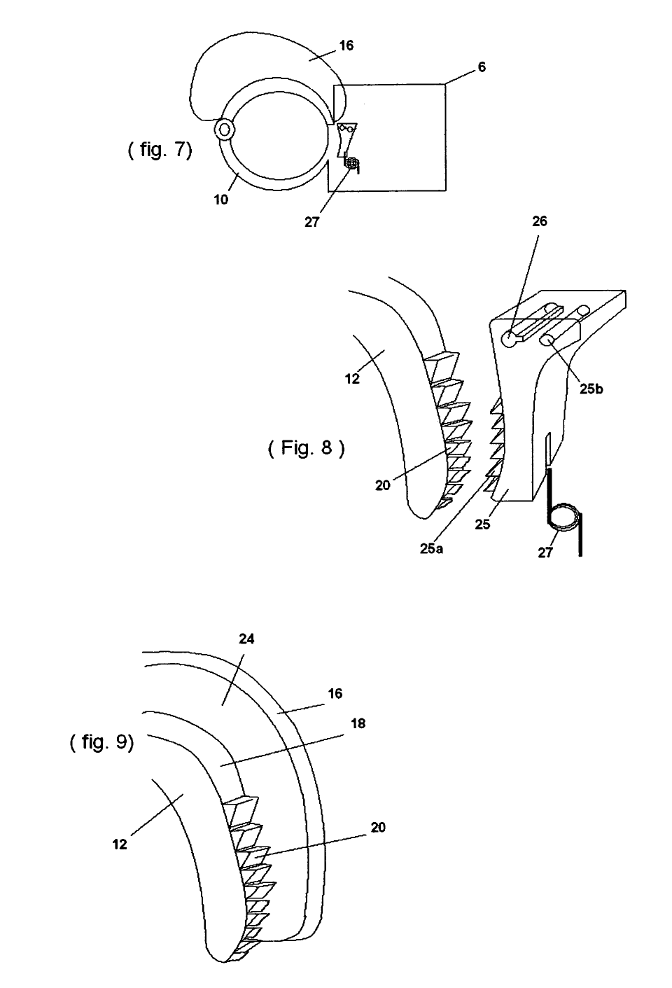

the central holder 6 is located just to the right of the first bracelet 4. As shown in FIGS. 7 and 8, the central holder 6 contains paws 22 which allow the ratchets 20 of the first bracelet 4 to assume a tighter position but prevent a loosening of the ratchets 20. The key unlocking mechanism 25 is located in the central holder 6. The key unlocking mechanism 25 is a conventional unlocking mechanism having a keyhole 26 and is held in place by a torsion spring 27.

the central holder 6 contains a one-way clutch 28 held in the left side thereof. This one-way clutch 28 is best seen in FIG. 5 which shows the working of a

Preferred one-way clutch 28. The clutch 28 is held within the holder 6. Compression coil springs 30 apply constant pressure against the supporting shaft 32 which holds the one-way clutch 28. The clutch 28 is circular in shape and contains an axle 34 which is held in a horizontal slot 36 in the central holder 6. The axle 34 ends at a cover plate 38 at each end.

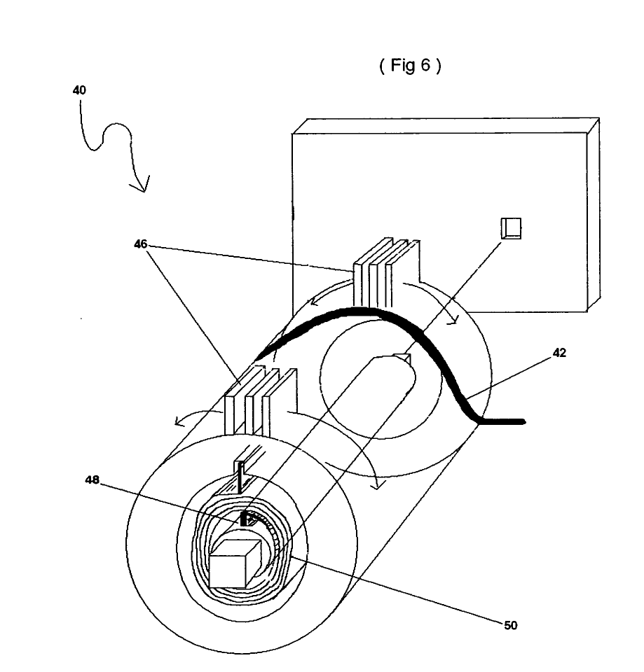

The central holder 6 also contains a retraction mechanism 40. This device is best shown in FIG. 6 which shows a preferred retraction mechanism 40. A distal end on the line 42 is attached to the second bracelet 8 and the proximal end of the line 42 is wrapped around, and is secured to, the outer shaft 46. An inner shaft 48 fits inside the outer shaft 46. The inner shaft 48 is immobile and does not turn with the outer shaft 46. A spiral torsion spring 50 is connected at one end to the outer shaft 46 and at the other end to the inner shaft 48.

The second bracelet 8 is found on the right. This bracelet 8 is attached to the distal end of the line 42 which runs from the outer shaft 46.

The operation of the above described handcuffs 2 will now be described.

As seen in FIG. 6, the outer shaft 46 is caused to move in a clockwise direction by pulling on the line 42 when the retraction mechanism 40 is not engaged by the key unlocking mechanism 25. This turning applies tension to the spiral torsion spring 50. The outer shaft 46 is caused to turn in the counter-clockwise direction when the pulling pressure is stopped and the line 42 becomes slack.

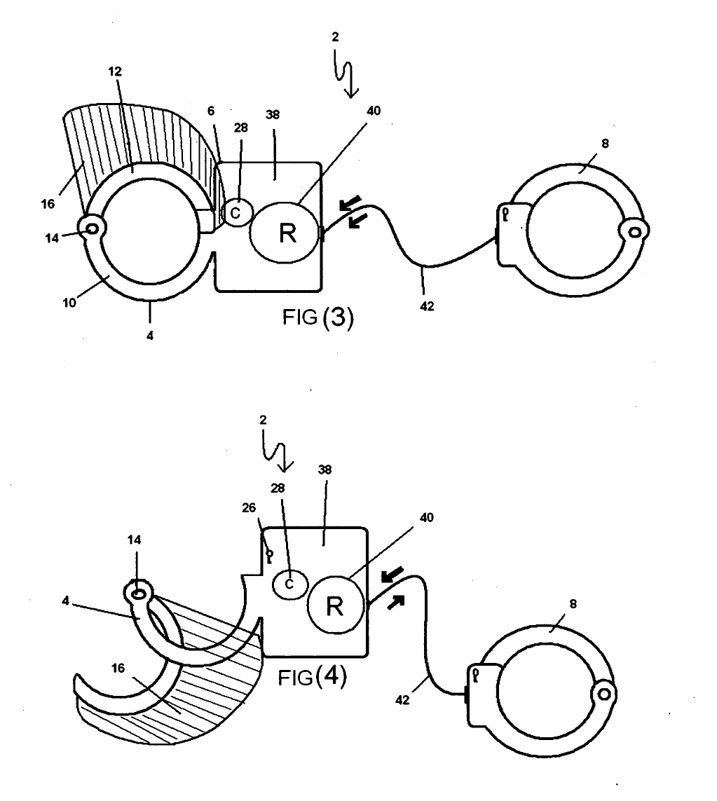

FIGS. 2, 4, and 8 show that when the first bracelet 4 is open the pawls 22 of the unlocking mechanism 25 do not contact the ratchets 20 of the upper section 12 of the first bracelet 4, the clutch press mechanism 16 does not press against the clutch 28

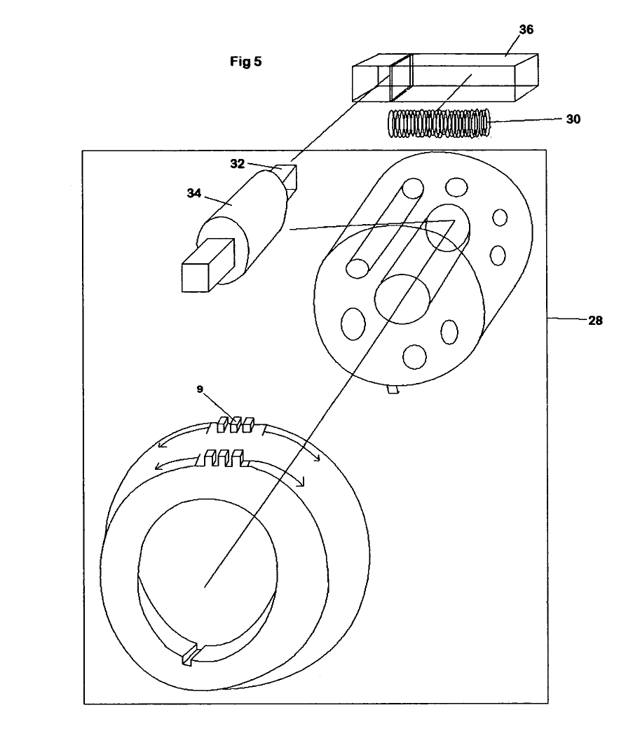

And the clutch 28 and the retraction mechanism 40 are not engaged. These Figures also show the line 42 extending between the retraction mechanism 40 and the second bracelet 8. When the first bracelet 4 is open as is shown in FIG. 2 the compression spring 30 applies pressure to the support shaft 32 to push the clutch 8 away from the retraction mechanism 40. FIG. 4 shows the first bracelet 4 opened while the line 42 is still at a distance from the central holder 6. Opening of the first bracelet 4 causes the clutch 28 to separate from the retraction mechanism 40. The second bracelet 8 can then be repositioned as desired by the authority. When the first bracelet 4 is in the open condition, the line 42 may be extended of retracted. This line 42 may be extended if necessary to restrain an uncooperative subject whose hands are far apart. It can be readily appreciated that the second bracelet 8 should be applied to the subject first and the first bracelet 4 should be open during this operation. Then the first bracelet 4 may be applied.

when the first bracelet 4 is closed, the rounded outer surface of the clutch press mechanism 16, which is attached to the upper section 12 of the first bracelet 4, will press against the one-way clutch 28 as shown in FIG. 1 to urge the clutch 28 along the slot 36 so that it engages with the retraction mechanism 40 causing the line 42 connected to the second bracelet 8 to be urged toward the central holder 6. In this arrangement, the line 42 cannot be extended. Also, the ratchets 20 of the upper section 12 of the first bracelet 4 will engage with the pawls 22 of the unlocking mechanism 25 with the result that the first bracelet 4 cannot be opened.

FIG. 1 shows a set of handcuffs 2 wherein a first bracelet 4 and a second bracelet 8 are set apart at a predetermined distance. This Figure shows that the closing of

The first bracelet 4 will make the clutch press mechanism 16 press against the clutch 28, forcing the clutch 28 to engage with, and activate, the retraction mechanism 40. One-way clutches which may be used in the present invention are old in the art. Reference is made to the one-way clutches shown in U.S. Pat. Nos. 3,732,957, and 4,236,619, and 5,042,628. Also, retraction mechanisms are known in art. Reference is made to U.S. Pat. Nos. 3,941,330, 4,083,512, 5,245,761, and 5,377,626 to show retraction mechanisms.
These clutches and retraction mechanisms, or any similar clutches and retraction mechanism, may be used in this invention.

FIG. 3 shows the handcuffs 2 as they would appear following the application of the handcuffs 2 to a subject whose hands are far apart. It can be seen that the clutch press mechanism 16 presses against the one-way clutch 28 and that the one-way clutch 28 activates the retraction mechanism 40 so that any slack in the line 42 enables the line 42 to be pulled toward the central holder 6.

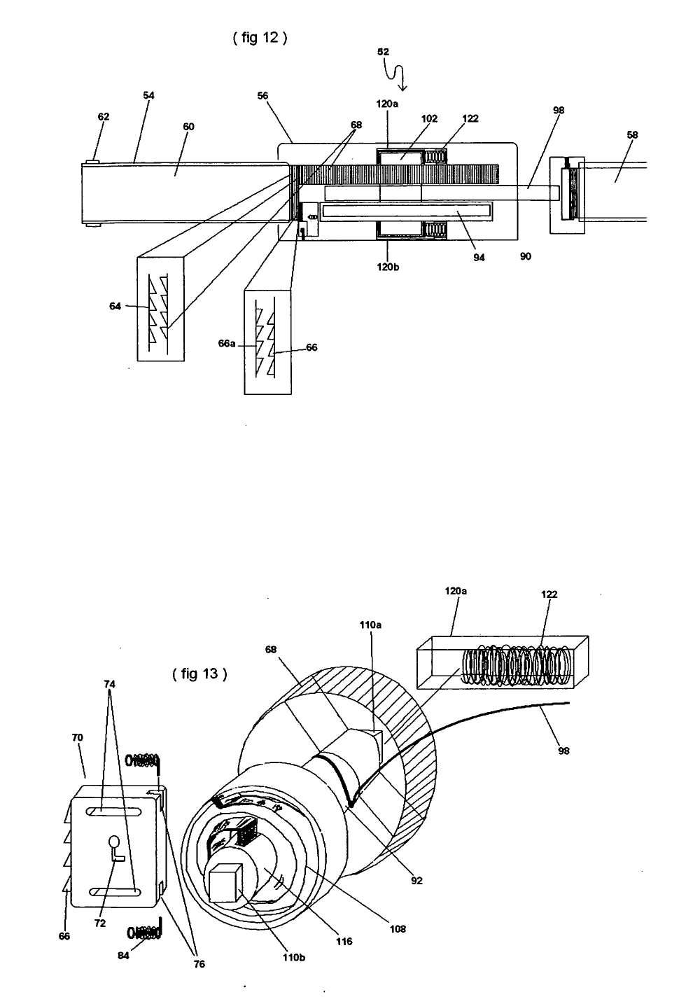

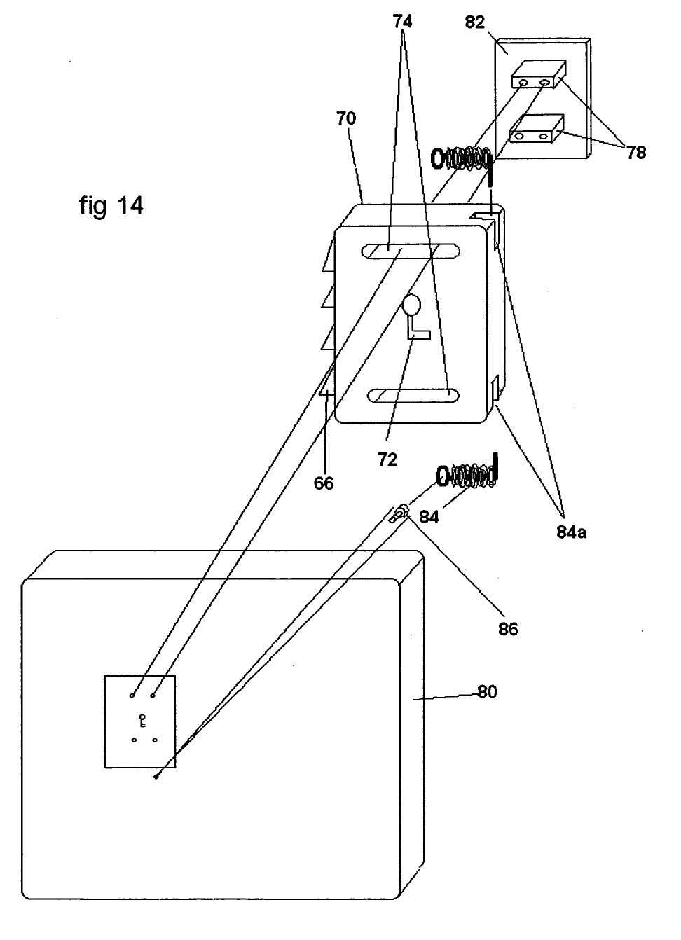

The handcuffs 52 of the second embodiment will now be described with reference to FIGS. 12-14. The handcuffs 52 of the second embodiment, like those of the first embodiment, are made up of a first bracelet 54 which is found on the left, a central holder 56, and a second bracelet 58 which is found on the right. As in the first embodiment, the first bracelet 54 has a lower section (not shown) and an upper section 60 joined by a pivot pin 62, which ratchets 64 mesh with two sets of corresponding pawls 68 located in the central holder 56 to allow the upper section 60 to travel downwardly in a tightening direction, but do not allow the upper section 60 to travel upwardly in a loosening direction.

the first set of pawls 66 is part of the key unlocking mechanism 70. The key unlocking mechanism 70 contains the pawls 66, a keyhole 72, upper and lower inner slots 74, and upper and lower outer slots 76. The keyhole 72 allows for the entrance of a conventional handcuff key which, when turned clockwise, forces the key unlocking mechanism 70 to the right in a conventional manner.

Spacers 78 in the form of rods of blocks are attached to the front wall 80 and a divider 82. These spacers 78 fit through the upper and lower inner slots 74. The spacers 78 allow limited right and left movement of the key unlocking mechanism 70.

upper and lower springs 84 are attached on their left sides to pins 86 on the front wall 80 or the divider 82 and on their right sides to holes (not shown) in the upper and lower outer slots 76 in the key unlocking mechanism 70. The springs 84 are biased to the left. Thus, when the key is turned clockwise the key unlocking mechanism 70 is moved to the right and the pawls 66 of the key unlocking mechanism 70 are separated from the ratchets 64 of the upper section 60 of the upper section 60 of the first bracelet 54. When the key is returned to the starting position, the key unlocking mechanism 70 is urged to the left by the springs 84 and the pawls 66 of the key unlocking mechanism 70 are engaged with the ratchets 64 of the upper section 60 of the bracelet 54 preventing upward movement of the ratchets 64.

The second set of pawls 68 lies along the periphery of the retractable gear 88. When the second set of pawls 68 is engaged with the ratchets 64 of the upper section 60 of the left bracelet 54, the ratchets 64 may move only downwardly. When there no engagement, the ratchets 64 may move in any direction.

the central holder 54 also contains a retractable mechanism 90. This mechanism 90 is made up of a gear portion 88, a line-attachment portion 92, and a spring-operated retracting portion 94. The distal end 96 of the line 98 is attached to the second bracelet 58 and the proximal end 108 of the line 98 is wrapped around, and is secured to, an outer shaft 102 which contains a hollow bore 104. An inner shaft 106 fits inside the outer shaft 102. The inner shaft 106 is immobile and does not turn with the outer shaft 102. A spiral torsion spring 108 is connected at one end to the outer shaft 102 and at the other end to the inner shaft 106.

From back to front, the inner shaft 106 contains a flat back section 110, a first round section 112, a second round section 114, a third round section 116, and a flat front section 118.

The flat back 112 and front 118 sections fit into, and slide right and left along, a spring press shaft 120. Coil compression springs 122 fit in the right hand side of the spring press shafts 120 and bias the inner shaft 106 to the left by pressing on the flat sections 110, 118 of the inner shaft 106.

The first round section 112 of the inner shaft 110 is adjacent to the portion of the outer shaft 102 which contains the retractable gear 88.

The second round section of the inner shaft 106 is adjacent to the portion of the outer shaft 102 to which the line 98 is attached. As the line 98 is pulled outwardly the outer shaft 102 turns counterclockwise. As the outer shaft 102 is turned clockwise the line 98 is retracted.

The third round section 116 of the inner shaft 106 is adjacent to the portion of the outer shaft 102 which contains the spiral torsion spring 108 which is responsible for creating the force which retracts the line 98.

The operation of the handcuffs 52 of the second embodiment will now be described.

The starting point for using the handcuffs is with the right 58 and left 54 bracelets in the open condition and the line 98 extended. The right bracelet 58 is then applied to one wrist of the subject and closed. The left bracelet 58 is then applied to the other wrist of the subject and closed. The springs 84 of the key unlocking mechanism 70 act to keep the left bracelet 58 in a locked condition. The coil compression springs 122 bias the inner shaft 106 to the left forcing engagement of the second set of pawls 68 with the ratchets 64 of the left bracelet 54. In this condition, the retractable gear 88 may be turned clockwise, but not counterclockwise. Clockwise rotation of the retractable gear 88 causes the line 98 to be retracted thus bringing the subject's hands closer to each other.

since the retractable gear 88 cannot be turned in a counterclockwise direction the line 98 attached to the outer shaft 102 cannot be extended but can only be retracted. As the spiral torsion spring 108 connecting the outer shaft 102 and the inner shaft 106 is put under tension when the outer shaft 102 is moved in a counterclockwise direction the line 98 will be retracted whenever there is slack in the line 98.

When a key is turned clockwise in the key unlocking mechanism 70 the key unlocking mechanism 70 moves to the right. The pressure of the key unlocking mechanism 70 against the portion of the outer shaft 102 which contains the spiral torsion spring 108 forces the retractable mechanism 90 to the right. When the pawls 66,68 associated with the key unlocking mechanism 70 and the retractable mechanism 90 move to the right the ratchets 64 of the left bracelet 54 may move upwardly and the left bracelet 54 may be opened.

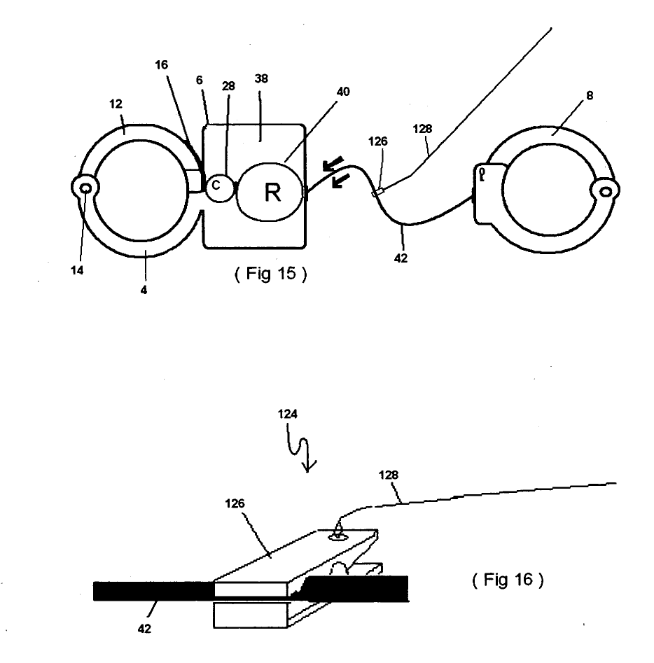

The line stopper 124 of the present invention will be described with reference to FIGS. 15 and 16.

As can be readily appreciated, cuffs having retractable lines are useful when applied to either the wrists or ankles of a subject. In both cases there may be times when the lines should be extended so as to allow the subject to move freely. It can also be appreciated that this freedom of motion should be under the control of the authorities. The line stopper 124 of this invention allows for this condition.

The line stopper 124 of this invention is made up of an attachment piece 126 and a connection line 128. FIG. 15 shows a set of handcuffs 2 according to this invention with the attachment piece 126 of the line stopper 124 attached to the line 42 of the handcuffs 2. One end of the connection line 128 is attached to the attachment piece 126. The other end of the connection line 128 may be attached to or held by the authority. The attachment piece 126 of the line stopper 124 can fit snuggly and immovably on the line 42. When this is the case the line 42 may be retracted only to the attachment point of the line stopper 124. This offers the subject a greater degree of freedom of movement than would be possible if the line 42 was fully retracted. Should the authority retract the connection line 128 or should the subject move beyond the length of the connection line 128 the attachment piece 126 will be slipped off the line 42 and the line 42 may retracted.

Although the invention has been described and illustrated in detail, it is to be clearly understood that the same is by way of illustration and example, and is not to be taken by way of limitation. The spirit and scope of the present invention are to be limited only by the terms of the appended claims.

I claim:

1. A restrain device comprising a first bracelet and second bracelet wherein;
least one bracelet contain a retraction/extension mechanism having line operatively attach thereto, and other end of the line is operatively attached to other bracelet, said least one bracelet with a retraction/extension mechanism having a mechanism which control one way locking mechanism/one way clutch to be engage and disengaged from retraction/extension mechanism.

2. A restrain device of claim 1, wherein said mechanism which control one way locking mechanism/one way clutch can be mechanical/electronic mechanism.

3. A restrain device of claim 1, wherein said one way locking mechanism/one way clutch can be any mechanism formed to be function as one way locking/one way clutch.

4. A restrain device of claim 2, wherein said mechanical/electronic mechanism is control by remote control.
